(19) United States
(12) Patent Application Publication
(10) Pub. No.: US 2024/0419497 A1
(43) Pub. Date: Dec. 19, 2024

(54) AUTOMATED CREATION OF CUSTOM CONTROLLERS FOR CONTAINERS

(71) Applicant: VMware, Inc., Palo Alto, CA (US)

(72) Inventors: Viktoria Dimitrova Penkova, Sofia (BG); Zhivko Stoychev Zapryanov, Sofia (BG); Plamen Georgiev Georgiev, Sofia (BG); Pavel Diyanov Damyanov, Sofia (BG); Milena Petrova Atanasova, Sofia (BG); Kristiyan Kalchev, Sofia (BG); Angel Atanasov Yanev, Sofia (BG); Ihor Herasko, Sofia (BG)

(21) Appl. No.: 18/210,019

(22) Filed: Jun. 14, 2023

(51) Int. Cl. G06F 9/50; G06F 9/445

(52) U.S. Cl. CPC G06F 9/5033; G06F 9/44505

(57) ABSTRACT

The disclosure provides a method for automatically creating a custom controller for a container-based cluster. The method includes receiving input identifying one or more objects to include as part of a custom resource, the custom resource being an object deployable in a container-based cluster. The method further includes receiving, for each of the one or more objects, a configuration of corresponding one or more parameters of the object. The method further includes generating, based on the input and the configuration, a specification of a custom controller configured to manage the custom resource. The method further includes generating, based on the input and the configuration, a specification for the custom resource. The method further includes deploying the custom controller and the custom resource in a first container-based cluster using the specification of the custom controller and the specification of the custom resource.

Modern applications are applications designed to take advantage of the benefits of modern computing platforms and infrastructure. For example, modern applications can be deployed in one or more data centers, such as in a multi-cloud or hybrid cloud fashion. For example, an application may be deployed in a single cloud or across multiple clouds and thus consume both cloud services executing in a public cloud and local services executing in a private data center (e.g., a private cloud). Within the public cloud or private data center, modern applications can be deployed onto one or more virtual machines (VMs), containers, application services, and/or the like.

A container is a package that relies on virtual isolation to deploy and run applications that access a shared operating system (OS) kernel. Containerized applications, also referred to as containerized workloads, can include a collection of one or more related applications packaged into one or more groups of containers, referred to as pods. Containerized workloads run on a container orchestration platform that enables the automation of much of the operational effort required to run containers having workloads and services. This operational effort includes a wide range of things needed to manage a container's lifecycle, including, but not limited to, provisioning, deployment, scaling (up and down), networking, and load balancing.

Kubernetes® (K8S®) software is an example open-source container orchestration platform that automates the deployment and operation of such containerized workloads. In particular, Kubernetes may be used to create a cluster of interconnected nodes, including (1) one or more worker nodes that run the containerized workloads (e.g., in a worker plane) and (2) one or more control plane nodes (e.g., in a control plane) having control plane components running thereon that control the cluster. Control plane components make global decisions about the cluster (e.g., scheduling), and can detect and respond to cluster events (e.g., starting up a new pod when a workload deployment's intended replication is unsatisfied). As used herein, a node may be a physical machine, or a VM configured to run on a physical machine running a hypervisor.

Control plane components include one or more controllers of the control plane. A controller is configured to implement one or more control loops, called controller processes, which watch the state of the cluster and try to modify the current state of the cluster to match an intended state (also referred to as a desired state) of the cluster. For example, an administrator, may describe specifications of objects (e.g., pods, deployments, services, replica sets, etc.) that will run containers in the cluster. These specifications describe the intended state of the objects. In an example, the administrator may define the specifications of objects, such as in one or more YAML files. The administrator may provide the specifications to an application programming interface (API) of the control plane to create the objects and manage the objects to match the intended state.

One type of object includes custom resources. A custom resource is an object that extends the API of the control plane or allows a user to introduce their own API into the cluster. For example, a user may generate a custom resource definition (CRD), such as in a YAML file, the CRD defining the building blocks (e.g., structure) of the custom resource. Instances of the custom resource as defined in the CRD can then be deployed in the cluster, such as by using a custom resource specification that describes an intended state of the custom resource.

The controller of the control plane may not be able to monitor custom resources, as the controller may not have domain-specific knowledge as to how to manage (e.g., scale, upgrade, reconfigure, etc.) the custom resources. Accordingly, the controller may not be capable of keeping the current state of custom resources in sync with the intended state as defined in custom resource specifications.

Accordingly, in some cases, a custom controller (also referred to as an operator) is used to deploy and manage custom resources. An operator is an application-specific controller that extends the functionality of the API to create, configure, and/or manage instances of complex products, including custom resources, on behalf of a user. More specifically, an operator monitors and tracks custom resources to help ensure that the actual state of the cluster, including the state of the custom resources, and the desired state of cluster, as defined in custom resource specifications, are always in-sync within the cluster (e.g., via continuous monitoring of the custom resources). Whenever the state of a custom resource is different from what has been defined in a custom resource specification, an operator acts to reconcile the current state of the custom resource to be the state as defined in the custom resource specification. An operator can perform a number of actions, such as scaling, upgrading, reconfiguring, etc., objects, including custom resources, so as to make the state of the custom resources match the desired state defined in the custom resource specifications for the custom resources.

However, creating and deploying an operator manually is a complex multi-step task which requires a deep understanding of a container orchestration platform.

### SUMMARY

One or more embodiments provide a method for automatically creating a custom controller for a container-based cluster. The method includes receiving input identifying one or more objects to include as part of a custom resource, the custom resource being an object deployable in a container-based cluster. The method further includes receiving, for each of the one or more objects, a configuration of corresponding one or more parameters of the object. The method further includes generating, based on the input and the configuration, a specification of a custom controller configured to manage the custom resource. The method further includes generating, based on the input and the configuration, a specification for the custom resource. The method further includes deploying the custom controller and the custom resource in a first container-based cluster using the specification of the custom controller and the specification of the custom resource.

Further embodiments include a non-transitory computer-readable storage medium comprising instructions that cause a computer system to carry out the above methods, as well as a computer system configured to carry out the above methods.

### BRIEF DESCRIPTION OF THE DRAWINGS

FIG. 1A illustrates a computing system in which embodiments described herein may be implemented.

FIG. 1B illustrates an example cluster for running containerized workloads in the computing system of FIG. 1A, according to an example embodiment of the present disclosure.

FIG. 2 illustrates a block diagram depicting an operator management system for creating custom resources and operators.

FIG. 3 shows a flow diagram depicting a method for creating a custom resource and an operator.

FIGS. 4A-4C illustrate screens of an example user interface of an operator management system.

FIG. 5A illustrates an example custom resource definition template for building an operator specification.

FIG. 5B illustrates an example deployment template for building an operator specification.

FIG. 5C illustrates an example custom resource template.

FIG. 6A-6C illustrate an example operator specification.

FIG. 6D illustrates an example custom resource specification.

FIG. 7 illustrates a screen of an example user interface of an operator management system.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

Techniques for simplifying and automating the creation of custom resources and operators are discussed herein. In particular, certain aspects herein allow a user to provide simple input to an operator management system, such as through a graphical user interface (GUI), command line interface (CLI), etc. The input may include an identification of one or more objects to include as part of a custom resource, by including one or more definitions of the one or more objects in a CRD used to define a structure of the custom resource. The operator management system accordingly generates an operator specification, such as in a YAML file, for the operator and a custom resource specification, such as in a YAML file, for an instance of the custom resource to be controlled by the operator. The operator specification may include the CRD, such as within the YAML file of the operator specification.

The custom resource specification for an instance of the custom resource is different from the CRD defining the structure for the custom resource. In particular, the custom resource specification can be applied to a cluster via an API of a control plane of the cluster to deploy an instance of the custom resource and defines an intended state of the custom resource. The CRD defines the structure of a default custom resource, but not the intended state of a particular instance of the custom resource.

The operator specification can further be applied to the cluster, thereby deploying the operator to the cluster. The operator, based on the CRD included in the operator specification, then manages the instance of custom resource to ensure the state of the custom resource matches the intended state of the customer resource as defined in the custom resource specification. Therefore, the techniques herein allow for simple automated creation of custom resources and corresponding operators, through automated generation of custom resource specifications and operator specifications, in an automated fashion that eliminates the need for complicated programming. The techniques further help ensure that the operator and custom resource are properly configured and defined in the operator specification and custom resource specification, so as to run properly.

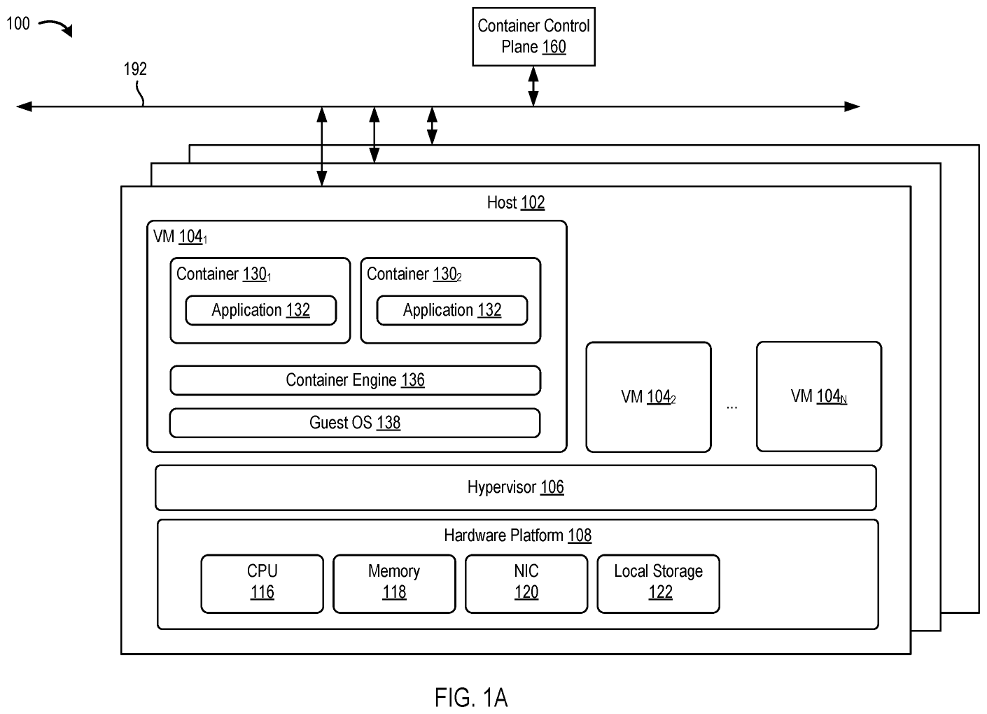

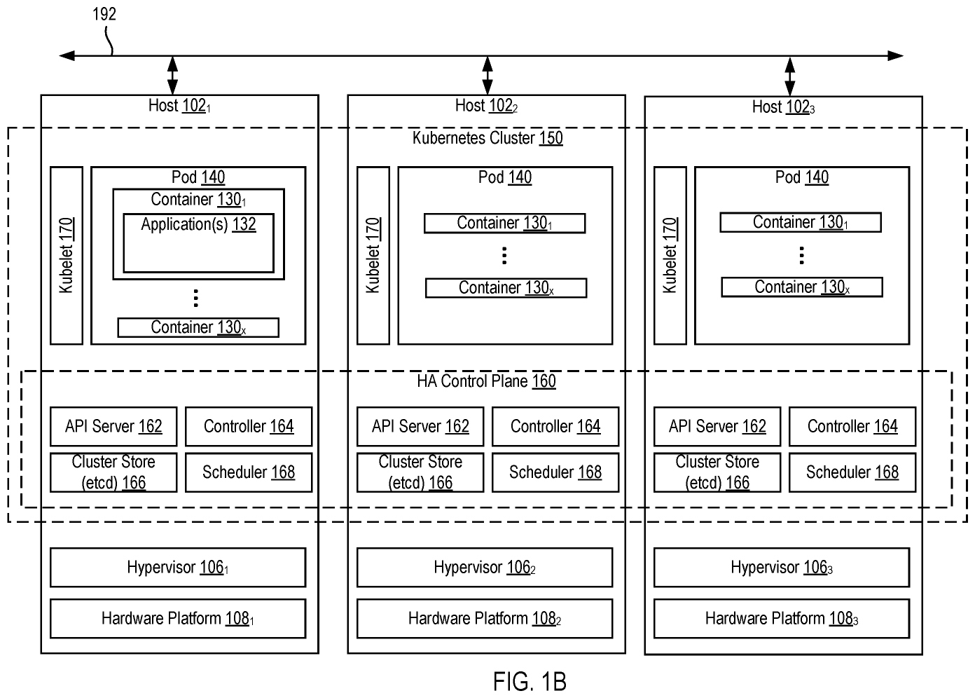

FIG. 1A is a block diagram that illustrates a computing system 100 in which embodiments described herein may be implemented. Computing system 100 includes one or more hosts 102 connected by a physical network 192. In particular, physical network 192 enables communication between hosts 102, and/or between other components and hosts 102. Though not shown, connections between components and hosts 102 may be via one or more additional networks and/or components. Computing system 100 may be a data center.

Hosts 102 may be in a single host cluster or logically divided into a plurality of host clusters. Each host 102 may be configured to provide a virtualization layer, also referred to as a hypervisor 106, that abstracts processor, memory, storage, and networking resources of a hardware platform 108 of each host 102 into multiple VMs 1041 to 104N (collectively referred to as VMs 104 and individually referred to as VM 104) that run concurrently on the same host 102.

Hardware platform 108 of each host 102 includes components of a computing device such as one or more processors (central processing units (CPUs)) 116, memory 118, a network interface card including one or more network adapters, also referred to as NICs 120, and/or storage 122. CPU 116 is configured to execute instructions that may be stored in memory 118 and, optionally, in storage 122.

In certain aspects, hypervisor 106 may run in conjunction with an operating system (not shown) in host 102. In some embodiments, hypervisor 106 can be installed as system level software directly on hardware platform 108 of host 102 (often referred to as “bare metal” installation) and be conceptually interposed between the physical hardware and the guest operating systems executing in the virtual machines. It is noted that the term “operating system,” as used herein, may refer to a hypervisor. In certain aspects, hypervisor 106 implements one or more logical entities, such as logical switches, routers, etc. as one or more virtual entities such as virtual switches, routers, etc. In some implementations, hypervisor 106 may comprise system level software as well as a “Domain 0” or “Root Partition” virtual machine (not shown) which is a privileged machine that has access to the physical hardware resources of the host. In this implementation, one or more of a virtual switch, virtual router, virtual tunnel endpoint (VTEP), etc., along with hardware drivers, may reside in the privileged virtual machine.

Each VM 104 implements a virtual hardware platform that supports the installation of a guest OS 138 which is capable of executing one or more applications. Guest OS 138 may be a standard, commodity operating system. Examples of a guest OS include Microsoft Windows, Linux, and/or the like.

The virtual hardware platform may include one or more virtual CPUs (VCPUs), a virtual random access memory (VRAM), a virtual network interface adapter (VNIC), and/or virtual host bus adapter (VHBA). For example, hypervisor 106 may be configured to implement the virtual hardware platform of each VM 104 as backed by the hardware platform 108 of host 102.

In certain embodiments, each VM 104 includes a container engine 136 installed therein and running as a guest application under control of guest OS 138. Container engine 136 is a process that enables the deployment and management of virtual instances (referred to interchangeably herein as “containers”) by providing a layer of OS-level virtualization on guest OS 138 within VM 104. Containers 130₁ to 130_{Y} (collectively referred to as containers 130 and individually referred to as container 130) are software instances that enable virtualization at the OS level. That is, with containerization, the kernel of guest OS 138, or an OS of host 102 if the containers are directly deployed on the OS of host 102, is configured to provide multiple isolated user space instances, referred to as containers. Containers 130 appear as unique servers from the standpoint of an end user that communicates with each of containers 130. However, from the standpoint of the OS on which the containers execute, the containers are user processes that are scheduled and dispatched by the OS.

Containers 130 encapsulate an application, such as application 132 as a single executable package of software that bundles application code together with all of the related configuration files, libraries, and dependencies required for it to run. Application 132 may be any software program, such as a word processing program.

In certain embodiments, computing system 100 includes a container control plane 160. Container control plane 160 is a computer program that resides and executes in one or more central servers, which may reside inside or outside the computer system 100, or alternatively, may run in one or more VMs 104 on one or more hosts 102 inside or outside the computer system 100. Container control plane 160 is an orchestration control plane, such as Kubernetes, configured to deploy and manage applications on VMs 104 and/or hosts 102 directly using containers 130. For example, Kubernetes may deploy containerized applications, as containers 130 and a control plane on a cluster of nodes (e.g., hosts 102 and/or VMs 104). Control plane 160 supports the deployment and management of applications on the cluster of nodes using containers 130. In some cases, the control plane 160 deploys applications as pods of containers running on nodes. Though certain aspects are described herein with respect to Kubernetes, including terminology used in Kubernetes, the techniques herein are similarly applicable to other container orchestration platforms.

An example container-based cluster for running containerized applications is illustrated in FIG. 1B. While the example container-based cluster shown in FIG. 1B is a Kubernetes cluster 150, in other examples, the container-based cluster may be another type of container-based cluster based on container technology, such as Docker® clusters.

As illustrated in FIG. 1B, Kubernetes cluster 150 is formed from a combination of one or more pods 140 including one or more containers 130 (e.g., for running applications 132), one or more kubelets 170, and control plane 160. Though components of cluster 150 are shown running directly on hosts 102 for ease of illustration, the components may be running on VMs 104 running on hosts 102. Further, although not illustrated in FIG. 1B, Kubernetes cluster 150 may include one or more kube proxies. A kube proxy is a network proxy that runs on each host 102 in Kubernetes cluster 150 that is used to maintain network rules. These network rules allow for network communication with pods 140 from network sessions inside and/or outside of Kubernetes cluster 150.

Kubelet 170 on each host 102 is an agent that helps to ensure that one or more pods 140 run on each host 102 according to a defined state for the pods 140, such as defined in specification(s) for the pods, such as in a configuration file (e.g., YAML file). Each pod 140 may include one or more containers 130.

Control plane 160 includes components such as an application programming interface (API) server 162, a cluster store (etcd) 166, a controller 164, and a scheduler 168. Control plane 160's components make global decisions about Kubernetes cluster 150 (e.g., scheduling), as well as detect and respond to cluster events (e.g., starting up a new pod 140 when a workload deployment's replicas field is unsatisfied).

API server 162 operates as a gateway to Kubernetes cluster 150. As such, a command line interface, web user interface, users, and/or services communicate with Kubernetes cluster 150 through API server 162. One example of a Kubernetes API server 162 is kube-apiserver. kube-apiserver is designed to scale horizontally—that is, this component scales by deploying more instances. Several instances of kube-apiserver may be run, and traffic may be balanced between those instances.

Cluster store (etcd) 166 is a data store, such as a consistent and highly-available key value store, used as a backing store for Kubernetes cluster 150 data. In certain aspects, cluster store (etcd) 166 stores one or more specifications of objects, such as in one or more configuration files, that declare intended system infrastructure and application(s) 132 to be deployed in Kubernetes cluster 150. In certain aspects, the specifications are included in JSON and/or YAML files.

Controller 164 is a control plane 160 component that runs and manages controller processes in Kubernetes cluster 150. As described above, control plane 160 may have (e.g., four) control loops called controller processes, which watch the state of Kubernetes cluster 150 and try to modify the current state of Kubernetes cluster 150 to match an intended state of Kubernetes cluster 150, such as defined in the specifications.

Scheduler 168 is a control plane 160 component configured to allocate new pods 140 to hosts 102. Additionally, scheduler 168 may be configured to distribute applications 132, across containers 130, pods 140, VMs 104, and/or hosts 102 that are assigned to use resources of hardware platform 108. Resources may refer to processor resources, memory resources, networking resources, and/or the like. In some cases, scheduler 168 may schedule newly created containers 130 to one or more VMs 104 of the hosts 102.

In other words, control plane 160 manages and controls every component of Kubernetes cluster 150. Control plane 160 handles most, if not all, operations within Kubernetes cluster 150, and its components define and control Kubernetes cluster 150's configuration and state data. Control plane 160 configures and runs the deployment, management, and maintenance of the containerized applications 132. As such, ensuring high availability of the control plane may be critical to container deployment and management. High availability is a characteristic of a component or system that is capable of operating continuously without failing.

Accordingly, in certain aspects, control plane 160 may operate as a high availability (HA) control plane. Additional details of HA control planes are disclosed in U.S. Application Ser. No. 63/347,815, filed on Jun. 1, 2022, and titled “Autonomous Clusters in a Virtualization Computing Environment,” which is hereby incorporated by reference herein in its entirety.

Aspects discussed herein provide an operator management system for automating the creation of custom resources and operators to be deployed on a container-based cluster, such as cluster 150.

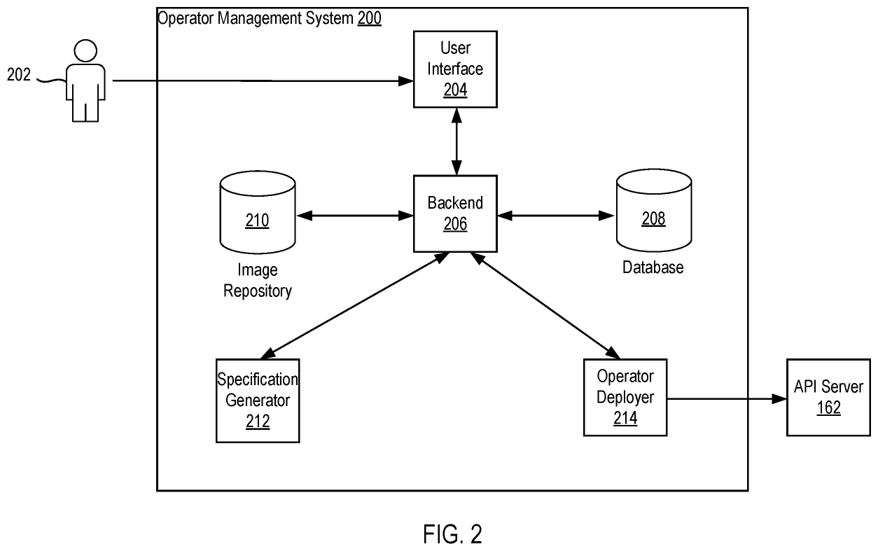

FIG. 2 illustrates a block diagram depicting an operator management system 200 for creating custom resources and operators. The operator management system 200 includes one or more computing devices (e.g., such as a server, workstation, virtual computing instance, host, pod, etc.) that run the various components of operator management system 200 described herein. The operator management system 200 may be within the same data center as a cluster 150 (FIG. 1B), or a different data center.

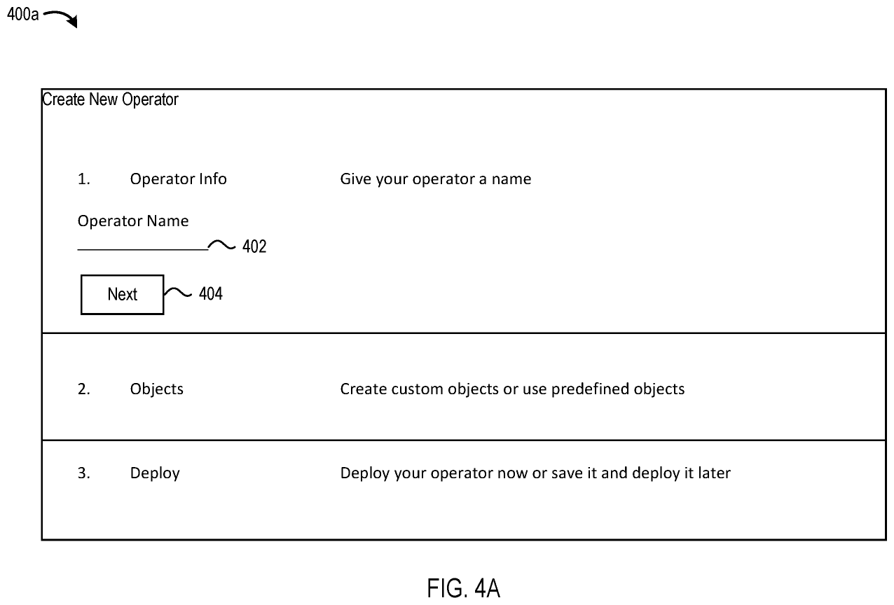

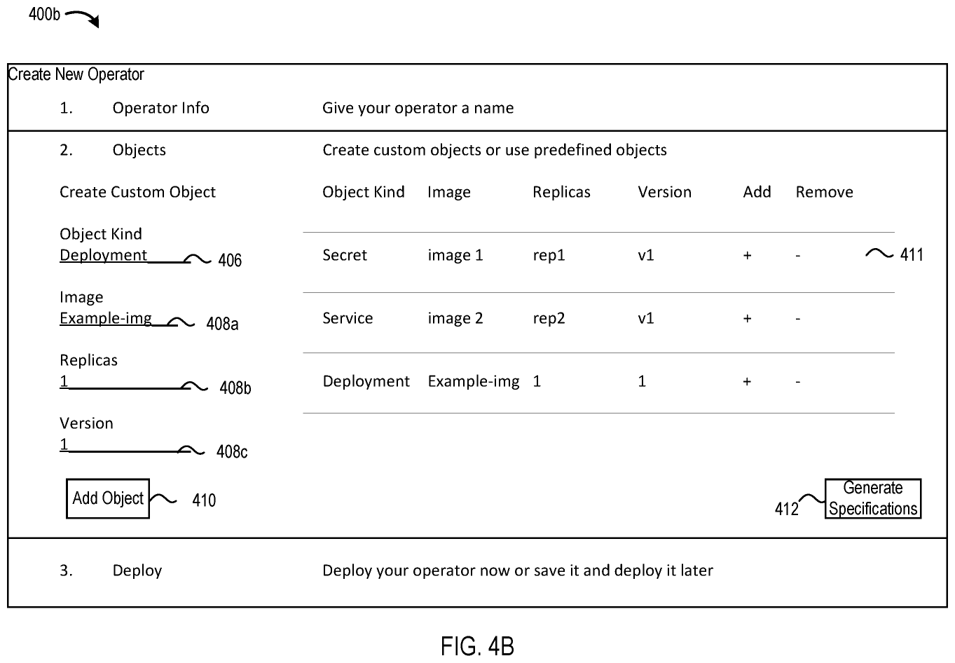

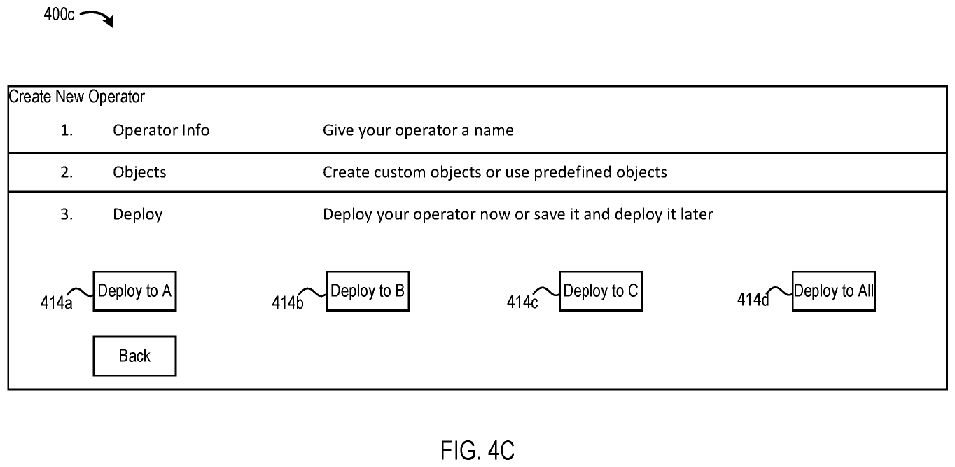

The operator management system 200 includes a user interface 204, which may run as a process on a computing device of operator management system 200. The user interface 204 is configured to provide a user interface to a user 202. The user 202, via the user interface 204, is able to provide input to the operator management system 200. FIGS. 4A-4C depict an example graphical user interface (GUI) provided by user interface 204.

The operator management system 200 further includes a backend 206, which may run as a process on a computing device of operator management system 200. The backend 206 is configured to handle requests from the user interface 204 and track a current state of each operator managed by operator management system 200. The state of each operator is stored in database 208. In certain aspects, the state includes a URL specifying a location of a generated operator specification (e.g., YAML files) for each operator.

In certain aspects, the backend 206 provides REST APIs, referred to as endpoints, that support various functions. The functions include 1) retrieving a list of all operators managed by backend 206, 2) retrieving parameter information for an operator, 3) removing an operator, 4) updating an operator, 5) retrieving a URL where a generated operator specification is accessible, 6) creating a new operator, 7) revert deployment of an operator to cause the cluster to be in the state prior to deployment of the operator, 8) checking status of an operator, and 9) checking health of backend 206.

The operator management system 200 further includes a specification generator 212, which may run as a process on a computing device of operator management system 200. Specification generator 212 is configured to create operator specifications and custom resource specifications. For example, specification generator 212 may receive a request from backend 206 to generate an operator specification and a custom resource specification for an operator and a custom resource, respectively. The operator specification may be generated as a first YAML file and the custom resource specification may be generated as a second YAML file. The two YAML files may be stored together. An identifier or resource locator of a container image may be further stored along with the operator specification and custom resource specification, as further discussed herein. The operator specification, as discussed, includes the CRD for the custom resource. The container image may be an image for a default operator, which once running in a cluster, is then configured according to the operator specification by the cluster controller, such as controller 164 of FIG. 1B.

In certain aspects, the specification generator 212 provides REST APIs, referred to as endpoints, that support various functions. The functions include 1) generating and uploading files associated with a new operator for a custom resource, the files including the operator specification, custom resource specification, and/or container image, 2) deleting files associated with an operator for the custom resource, and 3) checking the health of specification generator 212.

The operator management system 200 further includes an operator deployer 214, which may run as a process on a computing device of operator management system 200. Operator deployer 214 is configured to deploy operators and associated custom resources in a container-based cluster, such as in cluster 150 via API server 162, such as by applying the generated operator specifications and custom resource specifications to the cluster. For example, deployer 214 may deploy operators and associated custom resources to a cloud environment, a locally running cluster, etc.

In certain aspects, the operator deployer 214 provides REST APIs, referred to as endpoints, that support various functions. The functions include 1) deploying an operator, 2) reverting deployment of an operator, and 3) checking the health of operator deployer 214.

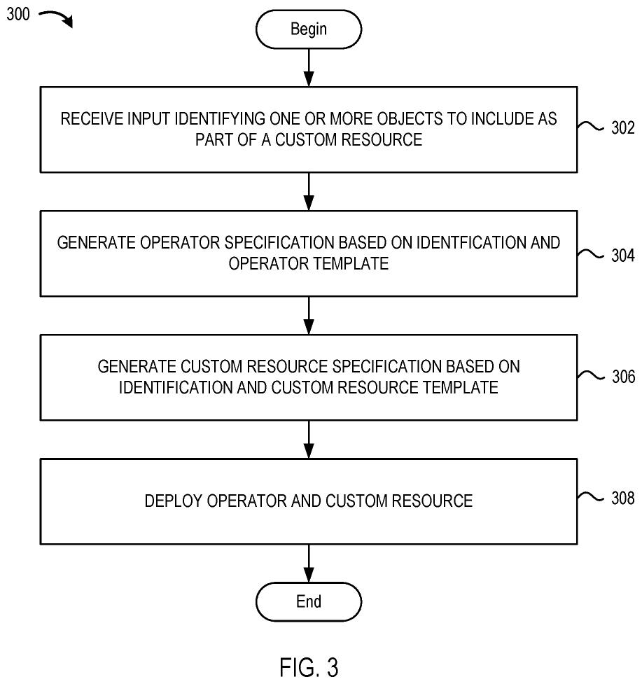

FIG. 3 shows a flow diagram depicting a method 300 for creating a custom resource and an operator.

At 302, the operator management system 200 receives input identifying one or more objects to include as part of a custom resource. In particular, as discussed further, the operator management system 200 is configured to include, for each of the one or more objects, a definition of the object in a CRD for the custom resource. For example, user 202 may provide the input via user interface 204. The user 202 may also provide, for each object identified, a configuration of one or more parameters of the object. The one or more parameters may include one or more of an image path (e.g., a path to a container image corresponding to the object), a number of replicas (e.g., indicating a number of instances of the object to deploy), a version, a port number, etc. The one or more parameters may be different for different kinds of objects. For example, for a deployment object, the one or more parameters include a number of replicas, an image path, and one or more port numbers for containers of the deployment. As another example, for a service object, the one or more parameters include a service exposure (e.g., indicating whether the service is reachable internally within the cluster and/or externally outside of the cluster) and a port number for the service.

In addition to identifying the one or more objects to be included in the custom resource, the user 202 may provide a name of the operator to be created. The one or more objects may be any kind of object, such as a deployment, a service, a secret, other object defined in Kubernetes, or custom objects, such as other custom resources.

FIGS. 4A-4C illustrate screens of an example GUI provided by user interface 204 in which user 202 can provide the input to the operator management system 200.

FIG. 4A illustrates an example operator information input screen 400a. Screen 400a includes an operator name input field 402 where a user 202 can provide a name for the operator to be created. The user 202 can then press the next button 404, causing the user interface 204 to display an object selection screen 400b as illustrated in FIG. 4B.

FIG. 4B shows by way of example a screen 400b for identifying objects to include as part of a custom resource to be managed by the operator. Screen 400b includes an object kind input field 406 where a user 202 can provide a kind of object to include as part of the custom resource. The screen 400b further includes object parameter input fields 408a-408c. User 202 can provide configuration of a parameter for the object indicated in the object kind input field 406 in each of object parameter input fields 408a-408c. As shown, object parameter input field 408a allows user 202 to indicate an image path for a deployment based on the user inputting deployment in the object kind input field 406. The container image may be stored, for example, in repository 210 of operator management system 200 shown in FIG. 2. Object parameter input field 408b allows user 202 to indicate a number of replicas for the deployment. Object parameter input field 408c allows user 202 to indicate a version for the deployment. In certain aspects, the number of object parameter input fields and type of parameter each object parameter input field is associated with in the user interface 204 is based on the kind of object indicated in the object kind input field 406.

Screen 400b includes an add object button 410, which when selected, adds, to a list of objects 411, an identification of (a) the kind of object indicated in object kind input field 406 and (b) configurations of parameters of the kind of object indicated in object parameter input fields 408a-408c. The list of objects 411 is displayed on screen 400b. User 202 can provide input to add or remove any of the objects identified in the list of objects 411 to a custom resource for which the operator management system 200 will generate an operator specification and a custom resource specification. Once user 202 has finalized the selection of objects to be part of the custom resource, user 202 can select the generate specifications button 412, which starts the process of creating the operator specification and custom resource specification for the custom resource including the objects listed in list of objects 411.

At 304, operator management system 200 generates an operator specification based on the identification of the one or more objects at 302 and based on one or more operator templates. For example, the operator specification may be an operator YAML file.

In certain aspects, the user interface 204 passes the input information, including operator name, identifiers of one or more objects, and one or more parameters for each object to backend 206, such as using a REST API. Backend 206 further passes the input information to specification generator 212, such as using a REST API.

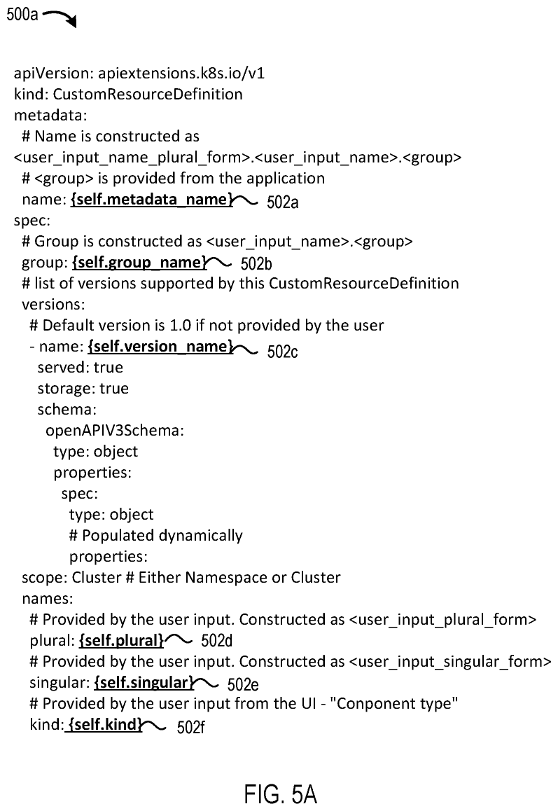

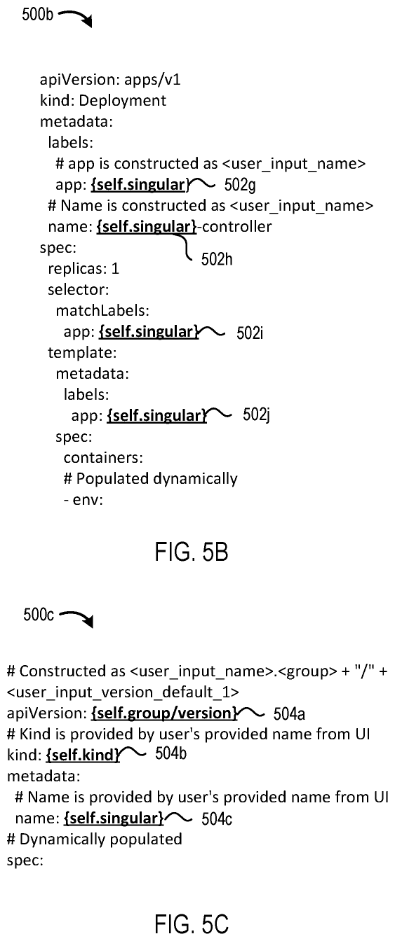

Specification generator 212 generates the operator specification based on the input information. For example, specification generator 212 may access a first operator template 500a, such as shown in FIG. 5A. The first operator template 500a illustrates a CRD template used to create a CRD that is added to the operator specification. The specification generator 212 may further access a second operator template 500b, such as shown in FIG. 5B. The second operator template 500b illustrates a deployment template used to create a deployment specification that is added to the operator specification. Accordingly, when the operator specification is applied to a cluster, the deployment is created on the cluster. This deployment is not an object of the custom resource defined by the CRD. Rather, the deployment creates or modifies instances of the operator in the cluster using an image of a default operator as discussed.

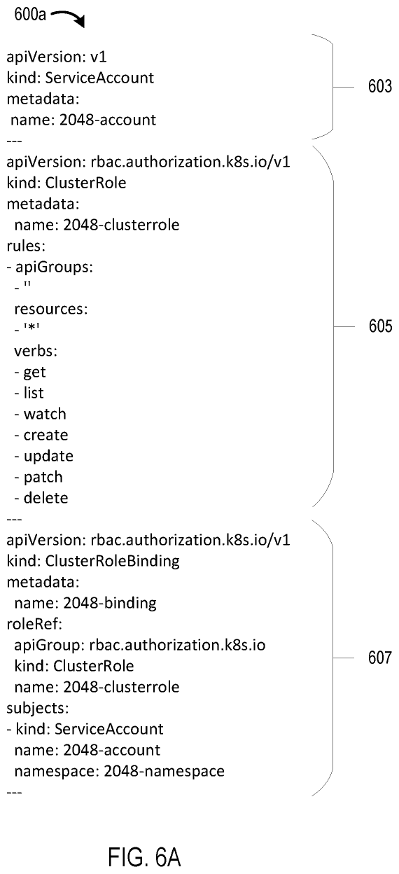

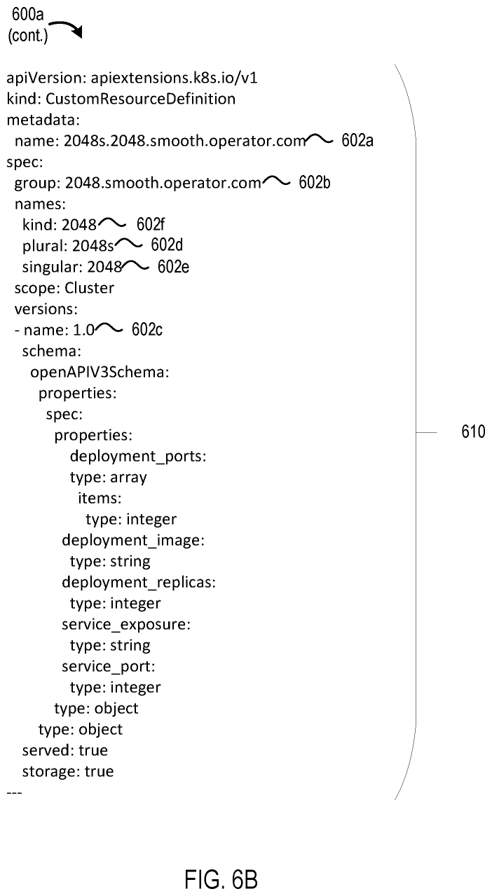

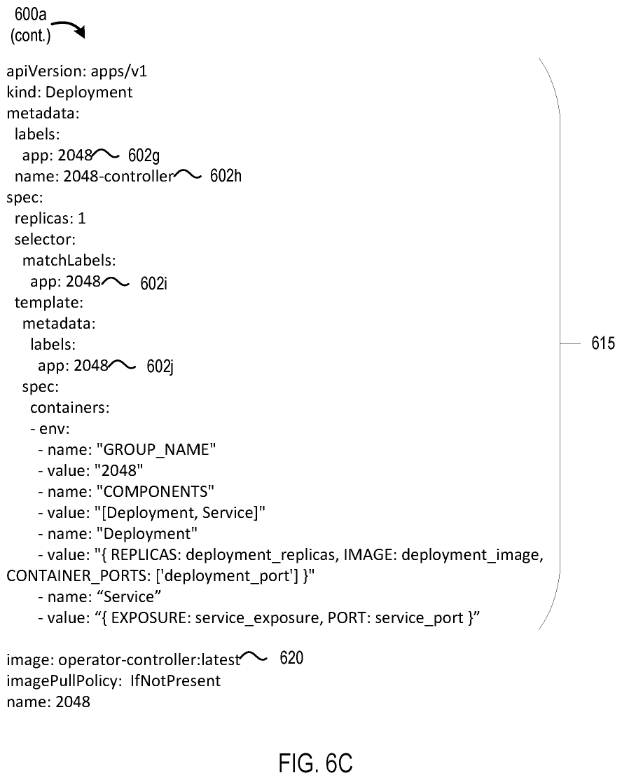

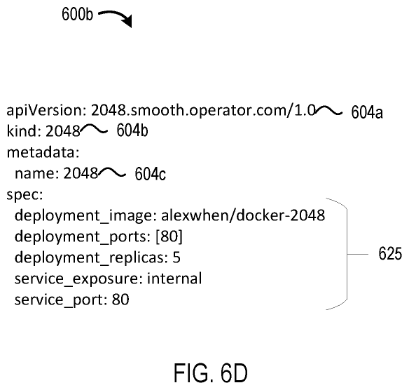

Operator templates 500a and 500b include a number of fields 502a-502j, each field 502a-502j mapping to a portion of the input information. The specification generator 212 maps the appropriate input information to each field 502a-502j in the operator templates 500a and 500b, thereby generating the operator specification. For example, specification generator 212 replaces each field 502a-502j in the templates 500a and 500b with the corresponding input information 602a-602j, respectively, to generate the operator specification 600a shown in FIGS. 6A-6C. In particular each field 502a-502j is shown replaced with respective input information 602a-602j.

As shown, the operator specification 600a includes specifications for five separate objects, a service account 603, a cluster role specification 605 for a cluster role, a cluster role binding 607, a CRD 610 for a custom resource, and a deployment specification 615 for a deployment. The specification for each object may be created based on an operator template for the object, where fields in the operator template are replaced by input information. Though certain example fields and input information are shown, it should be noted that operator templates may include other fields, which may be replaced with other input information.

The operator specification 600a further specifies a container image at 620. The container image specified at 620 is the image of the default operator discussed. Accordingly, when the operator specification 600a is applied/deployed to a cluster, the deployment is created on the cluster, which uses the container image to instantiate the operator on the cluster. The operator uses the CRD 610 to manage the custom resource.

Specification generator 212 further passes the generated operator specification to backend 206, such as using a REST API. Backend 206 stores the generated operator specification in repository 210.

At 306, operator management system 200 generates a custom resource specification based on the identification of the one or more objects at 302 and based on a custom resource template. In certain aspects, the custom resource specification is a custom resource YAML file.

In certain aspects, specification generator 212 generates the custom resource specification based on the input information. For example, specification generator 212 may access a custom resource template 500c, such as shown in FIG. 5C. The custom resource template includes a number of fields 504a-504c, each field mapping to a portion of the input information. The specification generator 212 maps the appropriate input information to each field 504a-504c in the custom resource template 500c, thereby generating the custom resource specification. For example, specification generator 212 replaces each field 504a-504c in the template 500c with the corresponding input information 604a-604c, respectively, to generate the custom resource specification 600b shown in FIG. 6D. In particular each field 504a-504c is shown replaced with respective input information 604a-604c. Further, custom resource specification 600b includes an indication of parameters 625 of the custom resource, which may be filled in using the input information indicating one or more parameters for each object.

Accordingly, when the custom resource specification 600b is applied/deployed to a cluster, an instance of the custom resource is deployed to the cluster, and the operator deployed based on operator specification 600a is configured to manage the custom resource, including reconciling the state of the custom resource to the state defined in the custom resource specification 600b using the CRD 610 in the operator specification 600a.

Specification generator 212 further passes the generated custom resource specification to backend 206, such as using a REST API. Backend 206 stores the generated custom resource specification in repository 210.

At 308, operator management system 200 deploys the operator and custom resource to one or more container-based clusters. For example, operator management system 200, via API server 162, applies the operator specification to cluster 150, and applies the custom resource specification to cluster 150. In certain aspects, controller 164 accesses container images indicated in the specifications from repository 210. In certain aspects, operator management system 200 uploads the container images to cluster 150, via API server 162, such as for storing in cluster store 166.

For example, FIG. 4C illustrates an example operator deployment screen 400c. Screen 400c includes buttons 414a-d. Each button 414 is associated with a different environment or set of environments. For example, button 414a is associated with environment A, button 414b is associated with environment B, button 414c is associated with environment C, and button 414d is associated with all of environments A-C. User 202 may select one or more of the buttons 414, which causes deployment of the operator and custom resource on the associated one or more environments.

For example, user interface 204 passes an indication to deploy the operator and custom resource on the one or more environments to backend 206, such as via a REST API. Backend 206 retrieves the corresponding operator specification and custom resource specification from repository 210, and passes the specifications to operator deployer 214, such as via a REST API. Operator deployer 214 applies the operator specification to cluster 150, and applies the custom resource specification to cluster 150, via API server 162. Accordingly, the operator and custom resource run in cluster 150, and the operator manages the custom resource.

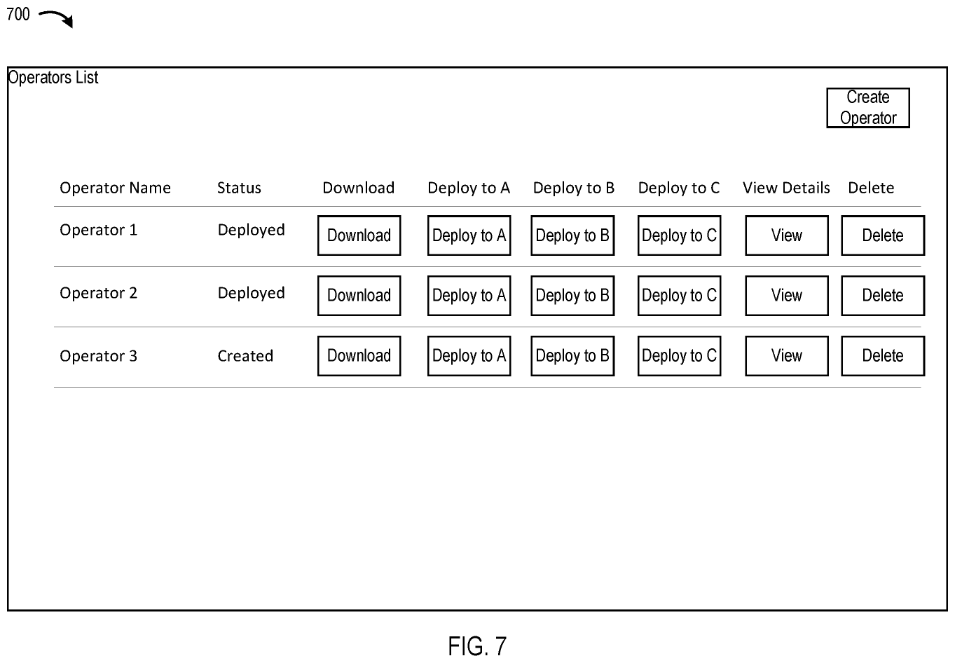

In certain aspects, operator management system 200 further provides a user interface to view and monitor deployed operators. FIG. 7 illustrate operator list screen 700 of an example GUI provided by user interface 204 in which user 202 can provide the input to the operator management system 200. As shown, operator list screen 700 includes a list of operators managed by operator management system 200. The details of each operator are shown as a separate row, including an indication of a status of the operator (e.g., deployed, created, etc.). Further, buttons are provided to allow user 202 to select whether to download the specifications of the operator, deploy the operator to an environment, view details (e.g., objects and associated parameters), or delete the operator.

It should be understood that, for any process described herein, there may be additional or fewer steps performed in similar or alternative orders, or in parallel, within the scope of the various embodiments, consistent with the teachings herein, unless otherwise stated.

The various embodiments described herein may employ various computer-implemented operations involving data stored in computer systems. For example, these quantities may take the form of electrical or magnetic signals, where they or representations of them are capable of being stored, transferred, combined, compared, or otherwise manipulated. Further, such manipulations are often referred to in terms, such as producing, identifying, determining, or comparing. Any operations described herein that form part of one or more embodiments of the invention may be useful machine operations. In addition, one or more embodiments of the invention also relate to a device or an apparatus for performing these operations. The apparatus may be specially constructed for specific required purposes, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

The various embodiments described herein may be practiced with other computer system configurations including hand-held devices, microprocessor systems, microprocessor-based or programmable consumer electronics, minicomputers, mainframe computers, and the like.

One or more embodiments of the present invention may be implemented as one or more computer programs or as one or more computer program modules embodied in one or more non-transitory computer readable media. The term computer readable medium refers to any data storage device that can store data which can thereafter be input to a computer system-computer readable media may be based on any existing or subsequently developed technology for embodying computer programs in a manner that enables them to be read by a computer. Examples of a computer readable medium include a hard drive, network attached storage (NAS), read-only memory, random-access memory (e.g., a flash memory device), a CD (Compact Discs)—CD-ROM, a CD-R, or a CD-RW, a DVD (Digital Versatile Disc), a magnetic tape, and other optical and non-optical data storage devices. The computer readable medium can also be distributed over a network coupled computer system so that the computer readable code is stored and executed in a distributed fashion.

Although one or more embodiments of the present invention have been described in some detail for clarity of understanding, it will be apparent that certain changes and modifications may be made within the scope of the claims. Accordingly, the described embodiments are to be considered as illustrative and not restrictive, and the scope of the claims is not to be limited to details given herein, but may be modified within the scope and equivalents of the claims. In the claims, elements and/or steps do not imply any particular order of operation, unless explicitly stated in the claims.

Virtualization systems in accordance with the various embodiments may be implemented as hosted embodiments, non-hosted embodiments or as embodiments that tend to blur distinctions between the two, are all envisioned. Furthermore, various virtualization operations may be wholly or partially implemented in hardware. For example, a hardware implementation may employ a look-up table for modification of storage access requests to secure non-disk data.

Certain embodiments as described above involve a hardware abstraction layer on top of a host computer. The hardware abstraction layer allows multiple contexts to share the hardware resource. In one embodiment, these contexts are isolated from each other, each having at least a user application running therein. The hardware abstraction layer thus provides benefits of resource isolation and allocation among the contexts. In the foregoing embodiments, virtual machines are used as an example for the contexts and hypervisors as an example for the hardware abstraction layer. As described above, each virtual machine includes a guest operating system in which at least one application runs. It should be noted that these embodiments may also apply to other examples of contexts, such as containers not including a guest operating system, referred to herein as “OS-less containers” (see, e.g., www.docker.com). OS-less containers implement operating system-level virtualization, wherein an abstraction layer is provided on top of the kernel of an operating system on a host computer. The abstraction layer supports multiple OS-less containers each including an application and its dependencies. Each OS-less container runs as an isolated process in user space on the host operating system and shares the kernel with other containers. The OS-less container relies on the kernel's functionality to make use of resource isolation (CPU, memory, block I/O, network, etc.) and separate namespaces and to completely isolate the application's view of the operating environments. By using OS-less containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O. The term “virtualized computing instance” as used herein is meant to encompass both VMs and OS-less containers.

Many variations, modifications, additions, and improvements are possible, regardless the degree of virtualization. The virtualization software can therefore include components of a host, console, or guest operating system that performs virtualization functions. Plural instances may be provided for components, operations or structures described herein as a single instance. Boundaries between various components, operations and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations may be implemented as a combined structure or component. Similarly, structures and functionality presented as a single component may be implemented as separate components. These and other variations, modifications, additions, and improvements may fall within the scope of the appended claim(s).

We claim:

1. A method for automatically creating a custom controller for a container-based cluster, comprising:
receiving input identifying one or more objects to include as part of a custom resource, the custom resource being an object deployable in a container-based cluster;
receiving, for each of the one or more objects, a configuration of corresponding one or more parameters of the object;
generating, based on the input and the configuration, a specification of a custom controller configured to manage the custom resource;
generating, based on the input and the configuration, a specification for the custom resource; and
deploying the custom controller and the custom resource in a first container-based cluster using the specification of the custom controller and the specification of the custom resource.

2. The method of claim 1, wherein the specification of the custom controller is a first YAML file and the specification of the custom resource is a second YAML file, and wherein the first YAML file includes a custom resource definition corresponding to the custom resource.

3. The method of claim 1, wherein generating the specification of the custom controller is further based on an custom controller template comprising one or more fields, wherein each of the one or more fields maps to at least one of the identified one or more objects or at least one of the one or more parameters.

4. The method of claim 1, wherein deploying the custom controller and the custom resource comprises applying the specification of the custom controller and the specification of the custom resource to the first container-based cluster via an API server of the first container-based cluster.

5. The method of claim 1, wherein the one or more objects include one or more of a deployment, a service, or a secret.

6. The method of claim 1, wherein the specification of the custom controller specifies a container image for the custom controller, and wherein deploying the custom controller comprises instantiating the custom controller from the image of the custom controller.

7. The method of claim 1, further comprising managing a plurality of custom controllers.

8. A system comprising:
one or more processors; and
at least one memory, the one or more processors and the at least one memory configured to:
receive input identifying one or more objects to include as part of a custom resource, the custom resource being an object deployable in a container-based cluster;
receive, for each of the one or more objects, a configuration of corresponding one or more parameters of the object;
generate, based on the input and the configuration, a specification of a custom controller configured to manage the custom resource;
generate, based on the input and the configuration, a specification for the custom resource; and
deploy the custom controller and the custom resource in a first container-based cluster using the specification of the custom controller and the specification of the custom resource.

9. The system of claim 8, wherein the specification of the custom controller is a first YAML file and the specification of the custom resource is a second YAML file, and wherein the first YAML file includes a custom resource definition corresponding to the custom resource.

10. The system of claim 8, wherein generating the specification of the custom controller is further based on an custom controller template comprising one or more fields, wherein each of the one or more fields maps to at least one of the identified one or more objects or at least one of the one or more parameters.

11. The system of claim 8, wherein deploying the custom controller and the custom resource comprises applying the specification of the custom controller and the specification of the custom resource to the first container-based cluster via an API server of the first container-based cluster.

12. The system of claim 8, wherein the one or more objects include one or more of a deployment, a service, or a secret.

13. The system of claim 8, wherein the specification of the custom controller specifies a container image for the custom controller, and wherein deploying the custom controller comprises instantiating the custom controller from the image of the custom controller.

14. The system of claim 8, wherein the one or more processors and the at least one memory are further configured to manage a plurality of custom controllers.

15. One or more non-transitory computer-readable media comprising instructions that, when executed by one or more processors of a computing system, cause the computing system to perform operations for deploying a product having a plurality of microservices in a container-based cluster, the operations comprising:
receiving input identifying one or more objects to include as part of a custom resource, the custom resource being an object deployable in a container-based cluster;
receiving, for each of the one or more objects, a configuration of corresponding one or more parameters of the object;
generating, based on the input and the configuration, a specification of a custom controller configured to manage the custom resource;
generating, based on the input and the configuration, a specification for the custom resource; and
deploying the custom controller and the custom resource in a first container-based cluster using the specification of the custom controller and the specification of the custom resource.

16. The one or more non-transitory computer-readable media of claim 15, wherein the specification of the custom controller is a first YAML file and the specification of the custom resource is a second YAML file, and wherein the first YAML file includes a custom resource definition corresponding to the custom resource.

17. The one or more non-transitory computer-readable media of claim 15, wherein generating the specification of the custom controller is further based on an custom controller template comprising one or more fields, wherein each of the one or more fields maps to at least one of the identified one or more objects or at least one of the one or more parameters.

18. The one or more non-transitory computer-readable media of claim 15, wherein deploying the custom controller and the custom resource comprises applying the specification of the custom controller and the specification of the custom resource to the first container-based cluster via an API server of the first container-based cluster.

19. The one or more non-transitory computer-readable media of claim 15, wherein the one or more objects include one or more of a deployment, a service, or a secret.

20. The one or more non-transitory computer-readable media of claim 15, wherein the specification of the custom controller specifies a container image for the custom controller, and wherein deploying the custom controller comprises instantiating the custom controller from the image of the custom controller.
